(19) United States
(12) Patent Application Publication
(10) Pub. No.: US 2008/0208692 A1
(43) Pub. Date: Aug. 28, 2008

(54) SPONSORED CONTENT CREATION AND DISTRIBUTION

(75) Inventors: James H. Garaventi, Marblehead, MA (US); Alan B. Chebot, Newton Center, MA (US)

Correspondence Address: GOODWIN PROCTER LLP;PATENT ADMINISTRATOR, EXCHANGE PLACE, BOSTON, MA, 02109-2881, US

(73) Assignee: Cadence Media, Inc.

(21) Appl. No.: 12/037,594

(22) Filed: Feb. 26, 2008

Related U.S. Application Data
(60) Provisional application No. 60/903,783, filed on Feb. 26, 2007.

(51) Int. Cl. G06Q 30/00; G06F 17/00; G06Q 20/00; G06Q 99/00

(52) U.S. Cl. 705/14; 715/202; 705/1; 705/40; 705/26

(57) ABSTRACT

Users create custom media presentations by combining licensed content and sponsored content as selected by the user.

### CROSS-REFERENCE TO RELATED APPLICATIONS

This application claims priority to and the benefits of U.S. provisional patent application Ser. No. 60/903,783, filed on Feb. 26, 2007, the entire disclosure of which is incorporated herein by reference.

### FIELD OF THE INVENTION

The invention relates generally to facilitating the distribution of media content. More specifically, the invention relates to systems and methods for allowing consumers to legally obtain and create custom media presentations.

### BACKGROUND

The music industry has undergone a revolution. Fueled by digital music formats such as the CD and MP3 formats, the Internet and file-swapping websites such as NAPSTER and KAAZA, the traditional brick-and-mortar record shops no longer represent the front lines of music distribution and sales. It is estimated that in the United States, 18% of recorded music sales are made through digital channels, and as record companies and recording artists adapt, this figure will surely continue to rise.

However, the ease with which music can be purchased, copied and distributed without any degradation in quality threatens artists' and record companies' profits. For example, piracy of licensed music files through illegal file-sharing plagues the industry. Recent statistics indicate that for every legally-downloaded music file (via, for example iTUNES or some other pay-for-content site), forty illegal downloads take place. So while many consumers choose to buy music legitimately through direct purchases of CDs or individual tracks, streaming, or subscription services, many will continue to take advantage of the illegal avenues that provide the same music for free.

While traditionalists in music industry continue to resist “free” music as a business model, many media companies and artists are eager to experiment with new digital business models that address the reality of free music while preserving their revenue streams. Previous attempts to provide users with “free” content have focused on pre-packaged content, in which the licensee, an advertiser, or even a third party decides which content should be combined and how to combine it. Examples include playing commercials at the beginning or end of a song (known in the industry as a “pre-roll”) and providing advertisements or links to web pages as content is played. One reason such techniques do not appeal to users is because they have no “ownership” of the content and as a result the music is presented in a manner decided by another person, often someone with different tastes and interests.

In addition to the proliferation of online sharing of prepackaged or licensed content, numerous websites facilitate the creation and sharing of user-created content. For example, websites such as MySpace and YouTube allow users to build personalized web pages and upload content to be shared with others. While such a model works well for personal content such as home movies and photographs, use and distribution restrictions on licensed content (television clips, songs, movies, etc.) make it difficult (or even illegal) for users to include licensed content on such sites.

What is needed, therefore, is a method and supporting systems that allow owners of licensed content (e.g., music companies) to addresses the market realities of the availability of free content, enable users to experience the content in a personalized manner, while preserving licensing income stream for the content providers.

### SUMMARY OF THE INVENTION

In general, the present invention facilitates the selection and combination of media content into customized media presentations that include content as selected by users. The presentations can include various forms of media content, including licensed content, sponsored content, free content, user-generated content, etc. For example, a user selects licensed content (e.g., a music file, a collection of clips, news segments, a video, a movie or movie clip, a book on tape, or other digital media content) for downloading to a personal media device (e.g., an MP3 player, cell phone, PDA, etc.) and/or a computer. In some instances, the user may decide he is willing to pay for the music file and interact with the system to provide payment information and receive a legally-licensed copy of the music file. In some instances, however, he may decide that he does not wish to pay for the file, but wants to receive a legal copy of the file nonetheless. In such instances, he can select from a library of sponsored content (e.g., advertisements or other typically video-based content provided by a sponsor) with which the licensed content can be combined, thus creating a “custom” media presentation, such as a music video using a licensed song as the soundtrack for a sponsored advertisement. The sponsor may then compensate the licensor for the opportunity to have its sponsored content paired and possibly distributed with the licensed content. As a result, the user receives the desired licensed content for free, the sponsor increases the audience for its advertising message, and the licensor receives licensing fees for the downloaded content.

The essential character of the media creation and distribution system and techniques described herein is that users are able to decide themselves which content is to be included in a personalized media presentation and how they are to be combined, and, unlike conventional file-sharing websites, receive legal copies of licensed content at no cost. Furthermore, the user-selected content is combined in a manner such that it resembles a professionally produced presentation. Unlike prior art systems that dictate which commercials or advertisements a user must experience, or those that facilitate illegal downloads, the present system allocates licensing fees from an advertiser willing to pay for distributions of its ads to licensors of music and other media content based on user-created combinations of the media content and advertisements.

Accordingly, a method for providing electronic media content to users includes presenting licensed media content files attributed to a content licensor (such as audio and/or video files) and sponsored media content files attributed to a sponsor (such as audio and/or video advertisements) to a user and receiving from the user a request to combine the licensed media files with sponsored content. The method further includes combining the requested licensed media content files with the sponsored content files, thus creating a user-specified media presentation.

In some embodiments, the user-specified media presentation can be presented to the user, stored on a content server for subsequent retrieval and/or transmitted to a client device. In some implementations, a content identifier is provided to the user that facilitates the identification and retrieval of the user-specified media presentation from the content server. In such cases, the user-specified media presentation can be retrieved from the content server and provided to the user in response to receiving the content identifier. In some embodiments, the content identifier may be received from a requester other than the user, thereby allowing users to view and/or download presentations created by others.

The content licensor may be a record company, recording artist, or any other media company that owns or has legal authority to license media content. In some embodiments, the media content files (and in some cases the sponsored content files instead of or in addition to the licensed content files) are modified (e.g., edited, cut, shortened, lengthened, repeated, etc.) based on attributes of the licensed content files and/or attributes of the sponsored content files. The combination of the requested licensed content files and the sponsored files may, in some instances, be checked against content restriction policies. The content restriction policies may be supplied by the content licensor, the sponsor, or in some cases, both.

In certain implementations, the method also includes facilitating the payment of license fees from the sponsor to the content licensor. The receipt of requests for the user-specified media presentation and/or the provision of the user-specified media presentation to users can be tracked to determine, for example, the number of requests received, the number of requests fulfilled, the number of times viewed, the users that submitted such requests and/or whether the requests and responses thereto comply with distribution restriction policies. The payment of licensing fees may, in some cases, be based on the tracking results.

In another aspect of the invention a method for providing free, advertising-sponsored music downloads to consumers includes receiving a request to combine a user-selected licensed content file (e.g., an MP3 file) supplied by a first entity with a user-selected sponsored video file (e.g., a video commercial) attributed to a second entity. Based on attributes of the licensed content file and/or the sponsored video file, the licensed content file and/or the sponsored video file may be modified. The licensed content file and the sponsored video file are combined into a user-specified media presentation, and the payment of licensing fees among the entities is effectuated. In some instances, the attributes of the files may be provided with the files by the licensor, sponsor, users, and/or automatically determined.

In another aspect of the invention, a system for providing electronic media content to users includes a content server for receiving media content files, some of which are attributed to a content licensor and some being attributed to a sponsor. The system also includes a client communication server for receiving a request to combine media content files and a mixing module for combining the requested media content files, resulting in a user-specified media presentation. A payment module determines license payments due and facilitates such payments.

The system may also, in certain embodiments, include a database server for storing the media content files and/or the user-specified media presentation. A licensing server may be included to determine whether the received requests comply with one or more distribution restriction policies and/or content restriction policies. In some cases, the client communication server also receives requests to provide the user-specified media presentation to various client devices

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts or steps throughout the different views. Also, the drawings are not necessarily to scale, emphasis instead generally being placed upon illustrating the principles of the invention

FIG. 1 is a block diagram of a media content creation and distribution platform and the environment in which it operates according to an embodiment of the invention.

FIGS. 2A and 2B is a flow chart illustrating the participants and steps involved in using the media content creation and distribution platform of FIG. 1 according to an embodiment of the invention.

FIGS. 3-5 are exemplary application screens from one possible implementation of the media content creation and distribution platform of FIG. 1.

FIG. 6 is an exemplary application screen from a privately-branded implementation of the media content creation and distribution platform of FIG. 1.

### DETAILED DESCRIPTION

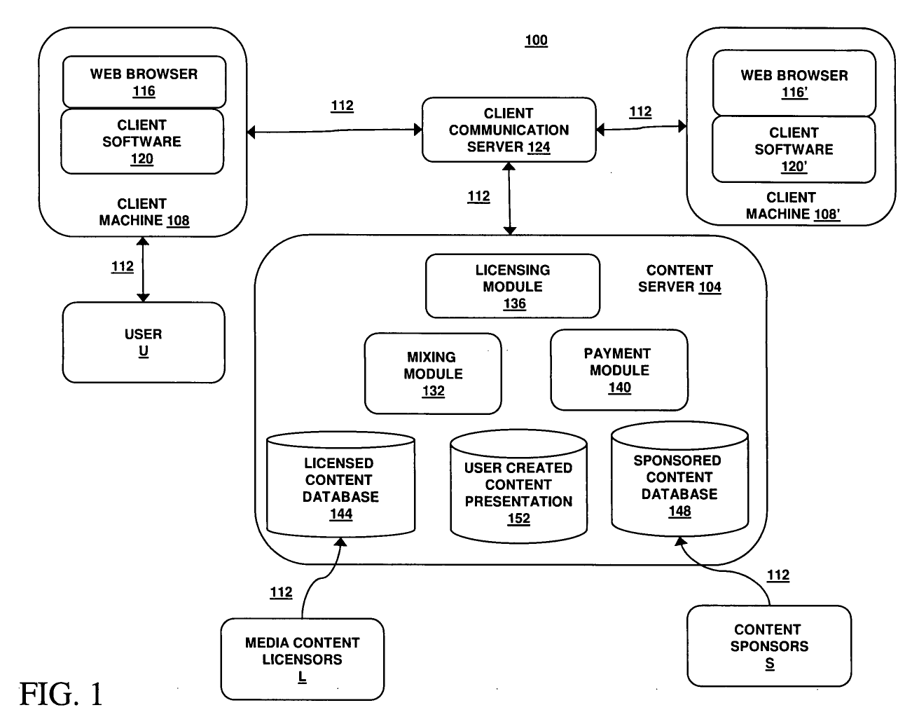

Referring to FIG. 1, in one embodiment, a content creation, compilation, licensing and distribution environment 100 includes at least one content server 104 and at least one client 108, 108′ (generally 108) communicating over one or more networks 112. As shown, the environment 100 includes two clients 108 and 108′, for exemplary purposes, however it is intended that there can be any number of clients 108. The client 108 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the OSX operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 108 may also be implemented on such hardware as a smart or dumb terminal, network computer, wireless device, personal data assistant, MP3 player, wireless telephone, information appliance, workstation, minicomputer, mainframe computer, or other computing device, that is operated as a general purpose computer, or a special purpose hardware device used solely for serving as a client 108 in the environment 100.

Generally, in some embodiments, clients 108 can be operated and used by users (“U”) to select, combine, create, publicize and distribute multimedia content via the Internet. Examples of such activities include, but are not limited to combining audio files (e.g., MP3, WAV) with video files (e.g., MPEG, WMV) to create custom “music videos.” Clients 108 can also be operated by media content licensors (e.g., record labels, artists, production companies, collectively referred to herein as licensors, or “L”) who own and/or license content to provide and/or monitor the use of their content by consumers. In addition, content sponsors “S” may also use the clients 108 to provide sponsored content to the system 100 to be used by the users U along with the licensed content provided by the licensors L. Licensed content as used herein may include any audio and/or video content protected by copyright or having other restrictions on distribution and display such as, but not limited to, songs, books on tape, movies, etc. Sponsored content may include any type of branded content, including advertisements, infomercials, etc. The clients 108 may also be operated by a facilitator (not shown), acting as an intermediary between the licensors L, sponsors S and users U.

In various embodiments, the client computer 108 includes a web browser 116, client software 120, or both. The web browser 116 allows the client 108 to request and/or interact with a web page or other downloadable program, applet, or document (e.g., from the server 104) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 108 manually requests a web page from the server 104. Alternatively, the client 108 automatically makes requests with the web browser 116. Examples of commercially available web browser software 116 are INTERNET EXPLORER, offered by Microsoft Corporation, NETSCAPE NAVIGATOR, offered by AOL/Time Warner, or FIREFOX offered the Mozilla Foundation.

In some embodiments, the client 108 also includes client software 120. The client software 120 provides functionality to the client 108 that allows user U to perform the activities described herein. The client software 120 may be implemented in various forms, for example, it may be in the form of a Java applet that is downloaded to the client 108 and runs in conjunction with the web browser 116, a Flash-based application, or the client software 120 may be in the form of a standalone application, implemented in a multi-platform language such as Java or in native processor executable code. In one embodiment, if executing on the client 108, the client software 120 opens a network connection to the server 104 over the communications network 112 and communicates via that connection to the server 104. The client software 120 and the web browser 116 may be part of a single client-server interface; for example, the client software can be implemented as a “plug-in” to the web browser 116. In some implementations, the client software 120 may be implemented using XML and Javascript (i.e., AJAX) such that data needed by the client software 120 can be retrieved from the server 104 asynchronously, thus reducing network traffic and bandwidth requirements.

A communications network 112 connects the client 108 with the server 104. The communication may take place via any media such as standard telephone lines, LAN or WAN links (e.g., T1, T3, 56 kb, X.25), broadband connections (ISDN, Frame Relay, ATM), wireless links (802.11, bluetooth, etc.), and so on. Preferably, the network 112 can carry TCP/IP protocol communications and HTTP/HTTPS requests made by the web browser 116, and the connection between the client software 120 and the server 104 can be communicated over such TCP/IP networks. The type of network is not a limitation, however, and any suitable network may be used. Non-limiting examples of networks that can serve as or be part of the communications network 112 include a wireless or wired Ethernet-based intranet, a local or wide-area network (LAN or WAN), and/or the global communications network known as the Internet, which may accommodate many different communications media and protocols.

The servers 104 interact with the clients 108. The server 104 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device, the amount of content stored and created using the system and the number of users and the size of the user base. For example, the server 104 may be or may be part of a logical group of one or more servers such as a server farm or server network. As another example, there could be multiple servers 104 that may be associated or connected with each other, or multiple servers could operate independently, but with shared data. In a further embodiment and as is typical in large-scale systems, application software could be implemented in components, with different components running on different server computers, on the same server, or some combination.

In one embodiment, the server 104 and clients 108 enable the distributed creation of multimedia content by users U from licensed content and advertisements provided by the licensors L and the content sponsors S, respectively. Furthermore, the server 104 can include various functional modules for storing, creating and tracking the licensed content, advertisements and user-created media content.

More specifically, the server 104 can, in some embodiments, include a communications server 124 for facilitating messaging and data transfer among the server 104 and the clients 108. For example, the communication server 124 provides a conduit through which the licensors L upload and track the use of licensed media content, sponsors S upload and track the use of sponsored content, and users provide instructions related to the creation and/or distribution of custom media presentations and generally interact with the server 104 and other users thereof. In some embodiments, the communication server 124 is or operates as part of the server 104 as described above, whereas in other cases the communication server 124 may be a separate server, which may be operated by and/or outsourced to an application service provider (ASP), internet service provider (ISP), or other third-party. Examples of commercially-available software applications that provide such functionality include WebSphere supplied by IBM and Apache supplied by the Apache Foundation.

In some embodiments, the server 104 may also include a mixing module 132 that facilitates the combination of licensed content (such as MP3 files for example) provided by the licensors L and sponsored content (typically video files that may or may not include their own soundtrack) provided by the content sponsors S, thus adding a soundtrack to the video file. For example, the mixing of licensed content and sponsored content may be automatic, in that the mixing module 132 automatically adjusts the length of the sponsored content (e.g., a video commercial) to match the length of the licensed content (a song) by cutting from the end, the start, and/or the body of the video. In some embodiments, the length of the sponsored content can be adjusted to match the length of the licensed content by adding content to, or extending the end, the start and/or the body of the advertisements. Some advertisements may include tags indicating how the advertisements may and/or may not be adjusted.

In one embodiment in which the sponsored content includes a video advertisement, the sponsor S may, in addition to providing the ad, also provide a data file containing time-referenced tags that indicate the sponsor's preferred editing options. For example, a 4½ minute video advertisement being paired with a 4 minute song may require the removal of thirty seconds of content from the ad. The sponsor S may indicate which “sections” of the ad can be removed and/or repeated by using “tags” such as the following:

```
<filename>pickuptruck
  <content_deletion>
    <start>00:00</start>
    <end>00:10</end>
    <start>00:30</start>
    <end>00:35</end>
    <start>04:15</start>
    <end>04:30</end>
  </content_deletion>
  <content_addition>
    <start>02:05</start>
    <end>02:10</end>
    <placement>02:15</placement>
  </content_addition>
</filename>
```

In the example above, the <content_deletion> tag indicates by time those sections of the ad that can be deleted in order to remove a total of thirty seconds from the ad, thereby matching the length of the licensed content with which it is being paired. Similarly, a <content_addition> tag may be used to indicate those section(s) of the ad may be repeated and at what point(s) in the ad to place them in instances in which the ad needs to be extended to match the length of the licensed content. In some cases, generic introductory and/or closing scenes may be added to or removed from the sponsored content if additional edits are necessary.

Similarly, and in some embodiments, the mixing module 132 may adjust the length of the licensed content to match the length of the sponsored content by cutting from the end, the front, and/or the body of the licensed content. In some implementations, the licensed content is scanned for placements of additional content or places where cutting of the licensed content may have a minimal effect on the user experience (e.g., long introductions, instrumental sections, a repeated chorus, etc.). In some cases, the length of the licensed content is adjusted to match the length of the sponsored content by repeating a portion of the licensed content by, for example, looping certain sections of the content.

In some implementations, the user U may also supply content to be combined with both the licensed content and the sponsored content. For example, a user may select a 4½ minute song and pair the song with a 3½ minute video supplied by a car company. Instead of instructing the mixing module to extend the video by one minute, the user may add her own sixty-second video clip to the mix, thereby creating a combination of licensed content (the song), sponsored content (the ad for a car) and her own user-generated content (perhaps a video of the user driving the same car off the dealership lot). The resulting media presentation now has value to all three parties—the content sponsor S has a new advertisement that can be distributed virally by loyal customers, the content licensor L receives payment from the sponsor S for use of the song (as described in greater detail below), and the user U has created unique content based on her likes and experiences she can share with the world at no cost.

The server 104 may also include a licensing module 136 to monitor the use, distribution and restrictions of the licensed content and the sponsored content. In some embodiments, licensed content may include a fee for use, which, for example, may be paid to the licensor L by the sponsor S that provided the sponsored content used by the user U to create her personalized media presentation. The licensed content may also include certain restrictions regarding its use in the system. For example, a licensor may restrict its content from being combined with certain sponsored content (e.g., a song targeting teenagers licensed by a family-oriented record label may not want their content paired with an advertisement for alcoholic beverages or an ad that contains risqué images). Similarly, certain sponsors may indicate a genre, artist, company or specific song with which they do not want to be paired, or, in the alternative, specifying those artists with whom they are to be paired. In some cases, specific partnership agreements may be in place that dictate the pairings of licensed content with certain sponsors, and vice versa. In such cases, the licensing module 136 determines if the paring of licensed content with a particular piece of sponsored content conforms to any restrictions indicated by the licensor L and/or the sponsor S. In some cases, the licensing module 136 may filter the content presented to the users based on the content restrictions, or delay posting of the resulting presentation pending a review be the licensor L, the sponsor S, or both.

In some embodiments, the licensing module 136 may create a unique license key that is associated with the user-created media presentation, without which it will not play. For example, to control the unauthorized copying and/or distribution of the user-created media presentation, the licensing module 136 can, in some cases, generate a unique hash code based on a unique identifier associated with the licensed content, the licensor, the sponsored content, the sponsor and/or the user, as well as other environmental parameters such as the date and/or time, IP addresses, MAC addresses, etc. The user-created media presentation can then be configured to require the presence of a valid license key (at the client, for example) to allow the presentation to render properly. In embodiments in which the user-created presentation is downloaded to the client, the license key can be transmitted along with or separately from the presentation, and in certain cases one or both may be encrypted.

The server 104 may also include a payment module 140 for initiating and tracking license payments due to the licensor L from the sponsor S. The payment module 140 may also track the distribution of the user-created presentation among users, such that each time a user (e.g., the user that created the presentation and/or other users) views, renders, copies, receives and/or distributes a copy of the presentation to another device and/or user, additional payments are required. For example, a first user may create a presentation that marries a sponsored advertisement with a licensed song for which the licensor requires a license payment of $1.00. Initially, the sponsor S provides the license fee to the licensor L in exchange for the opportunity to have its advertisement paired with the song. The user U can, in some embodiments, provide copies of the user-created presentation to other users (via, for example, email, posting the content on a website, providing a URL directed to the presentation as stored in a centrally-accessible server, etc.) such that other users can also experience the presentation, thus proliferating the distribution of not only the licensed content (the song) but the advertisement with which it was paired. The payment module 140, in conjunction with the licensing module 136, tracks each distribution, view and/or playback, and can initiate additional payments from the sponsor S to the licensor L for subsequent viewings and distributions. In some cases, the sponsor S may place limits on the amount of payments they are willing to pay, in which case the licensing module 136 may stop issuing keys for the content, utilize keys with a limited lifespan, and/or disable existing keys.

In some embodiments, the system may include one or more databases such as a media content database 144 for storing licensed content (e.g., music files), a sponsored content database 148 for storing sponsored content (e.g., advertisements), and a user-created presentation database 152 for storing user-created media presentation. For instance, the databases 144, 148 and 152 may store information relating to the licensed content and sponsored content such as usage and/or distribution restrictions defined by the licensors L and sponsors S. The databases may also store user information such as user IDs, passwords, preferences (e.g., favorite music, products, etc.) as well as other information. The user-created content database 152 may also provide personalized content to individual users based on demographics and usage statistics, such that a user's interaction with the system is unique, effectively providing a virtual “studio” in which the user can search for, create, view, store and/or share their creations. In some implementations, each user is presented a unique view, including a library of content created by the user, videos and/or songs having similar attributes or tags as previously viewed or used content, as well as links to other users' libraries having like interests. The databases 144, 148 and 152 provide data to the mixing module 132, payment module 140 and/or licensing module 136 as requested. Examples of database server applications that provides such functionality include the MySQL Database Server offered by Sun Microsystems of Mountain View, Calif., the PostgreSQL Database Server offered by the PostgreSQL Global Development Group of Berkeley, Calif., or the ORACLE Database Server offered by ORACLE Corp. of Redwood Shores, Calif.

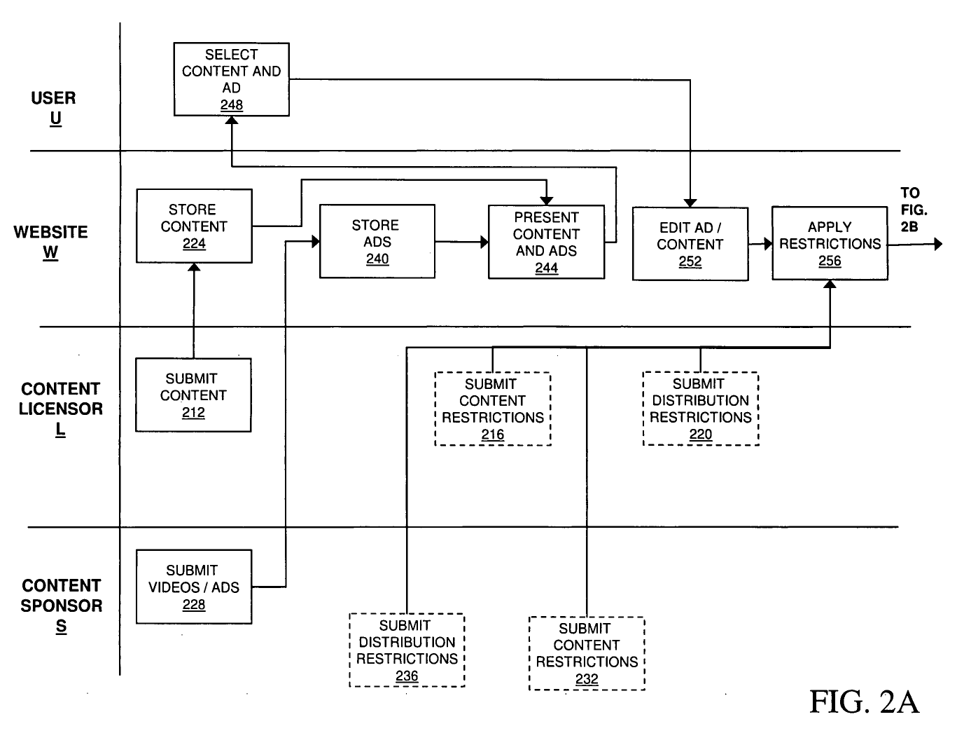

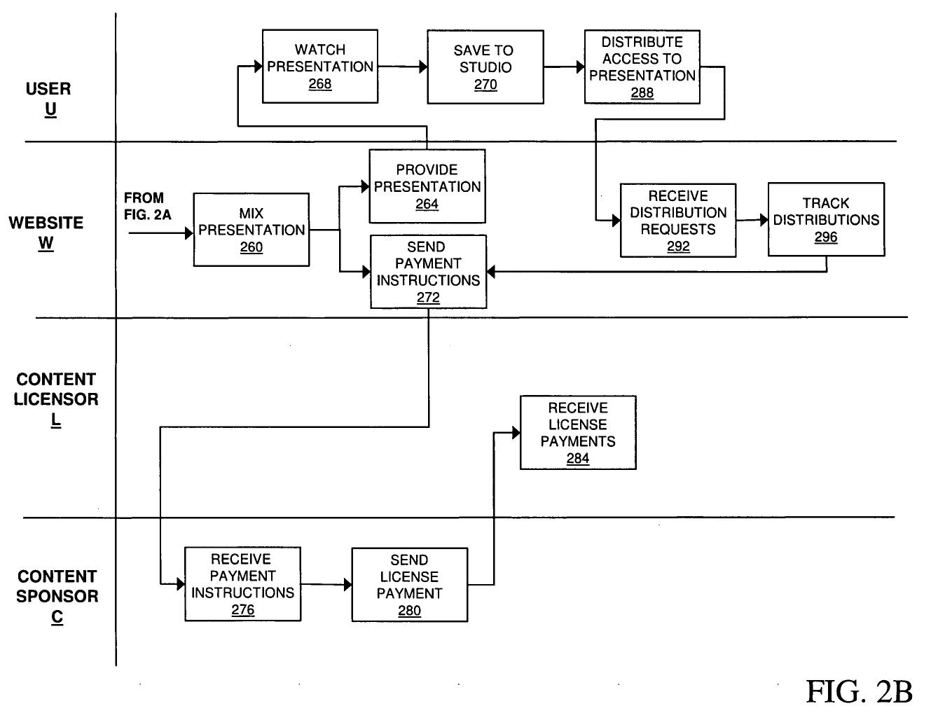

FIGS. 2A and 2B illustrate one embodiment of how the invention facilitates the creation of user-specified media presentations using the system described above. Content licensors L submit licensed content (STEP 212) to the system to be made available to users U, either for a fee or, if paired with sponsored content, for free. As described above, licensed content may include any licensed media in electronic form, such as videos, audio files, books on tape, images or any combination thereof for which licensor L would expect to receive license fees. The licensed content can be provided piecemeal or in batch, and typically via electronic means. In some instances, licensor L may provide computer-readable media containing the licensed content (e.g., a CD, DVD or other storage medium) to a website administrator W responsible for maintaining and operating the system. The content licensor L may also, in some embodiments, provide content restrictions (STEP 216) (e.g., sponsored content the licensed content is not to be paired with, limits on the duration or number of uses of the content, etc.) as well as distribution restrictions (STEP 220). Examples of distribution restrictions include a maximum number of distributions and/or whether and how the content can be shared among users. Once received by the website administrator W, the content and any associated restrictions are stored (STEP 224) in one or more databases as described above.

In many cases, licensed content becomes less valuable once it is freely copied and shared (especially over the Internet) and may not be able to generate revenue for the licensor. To guard against this, licensors are generally interested in maintaining the “proprietary” nature of their licensed content while allowing it to be distributed according to certain licensing terms and subject to license fees. However, this constraint often runs counter to market pressures that encourage the free distribution of such content. One method of achieving the goal of maintaining the value of the licensed content but still allowing the general public to freely download and distribute the content is to pair the licensed content with sponsored content that, by nature, is meant to be (and in fact encouraged to be) freely distributed. In such a manner, licensors can recoup otherwise lost revenue from sponsors that are willing to pay for the opportunity have their sponsored content paired and distributed with licensed content.

Therefore, in order to create a library of sponsored content with which users can pair licensed content, sponsor S submits sponsored content to the website administrator W (STEP 228). Although possibly similar in format to the licensed content, the sponsored content is primarily meant to be spread among users as freely as possible to provide maximum exposure for the products being offered by sponsor S. For example, sponsored content such as advertisements and videos that include prominent product placements, trademarks and other logos are generally developed to be freely shown and distributed as much as possible to maximize exposure of the product or service being promoted. To achieve such exposure, sponsors S are willing to pay for airtime, ad space, print space and emails to have sponsored content distributed though various marketing channels. Similar to the licensors L, sponsors S may, in some cases, provide content restrictions (STEP 232) and/or distribution restrictions (STEP 236). For example, a sponsor may wish to limit the number of times an advertisement is used and or distributed to limit its financial exposure. Sponsors may also wish to exercise some control over the licensed content with which an advertisements are paired. The sponsored content and any related restrictions are then stored (STEP 240) in the system for presentation to and use by the users (STEP 244).

In some cases, the sponsored content may include a collection of multiple clips or segments, thus allowing user U to select a subset of the clips to be paired with the licensed content. User U may then select some number of clips to include in his custom presentation. In some cases, the user is required to select a number of clips (or running length of clips) such that the sponsor's products or services are well-represented in the resulting media presentation. For example, the National Football League may provide a collection of the top twenty plays from football games played during a weekend, or the top ten clips for each team. A user wishing to download a song of a particular length may select the NFL highlight collection as the sponsored content to pair with the song, and, based on the length of the song, select eight of the thirty clips. In some cases, the total duration of the selected sponsored content may be long enough to “cover” the entire song, whereas in other cases additional content may be added. If the eight clips do not completely fill the length of the song, the user may, in some cases, add his own content (e.g., a video of his own high school football game). In some cases, restrictions are placed on amount of user-generated content that may be paired with licensed content in order to receive the content for free. The resulting presentation may be reviewed for appropriateness of content, running time, etc.

Users U register for and use the system described above to create customized user-specified media presentations (such as pairings of video advertisements and music) by visiting a website that facilitates the methods described herein. Preferably, users provide membership information about themselves during a registration step (not shown). Examples of membership information can include such information as the user's name, contact information (e.g., mail address, telephone number, email address, credit card information), a username (e.g., an “alias” or “handle”) for use on the site, websites the user manages (e.g., a “MySpace” page, or blog site), educational background, employment information, preferred format for receiving content (e.g., iPod, MPEG), certain demographic information and/or specific interests. The username is how the user will be known within the system to other users such that they are anonymous but recognizable. The registration may also include, for instance, completing a questionnaire to gather marketing data about the users. In some embodiments, the registration process initializes a personal “studio” in which the user can create, store, view, search for and/or share content with other users.

Once registered, a user U searches for and reviews licensed content available for downloading and/or purchase, as well as sponsored content with which to pair the licensed content. Users may also search for existing user-created presentations created by other users, or content tagged with certain keywords. As a result of registration, users may also receive e-mails and/or text messages (or some other form of promotional message) from sponsors encouraging the users to use the system and/or use certain sponsored content. In some cases, users can search licensed content by licensor, artist, and/or title, view the most popular content, or search by genre and/or mood. For example, searching the licensed content for audio files, users can select the most recent release from a particular artist, the most often downloaded song and search using metadata tags (e.g., “guitar solos,” “Elvis covers,” etc.). The system may suggest recently added licensed content based, for example, on content previously selected by the user (licensed, sponsored, or both), content selected or used by other users having similar demographics, or other collaborative filtering techniques.

Similarly, sponsored content can be searched by sponsor name, subject matter, most popular, brand, mood or other metadata tag associated with the sponsored content. The placement of sponsored content on the website and/or within the search results may be based on popularity (i.e., how often the sponsored content has been selected by other users), payments (how much the sponsor is willing to pay licensors or has paid to the website administrator), as well as combinations of other metrics. In some embodiments, certain web pages (e.g., search results pages, home pages, landing pages, etc.) may contain additional advertisements or offers from the sponsor, further increasing its exposure to the users and revenue opportunities for the website administrator W.

As examples, if user U wishes to download the most recent song by Ludacris but does not want to pay for the download, he may decide to pair it with an advertisement for a car, and because the car manufacturer benefits from the creation of the “custom” commercial, is willing to pay a license fee to the record company. In some instances, the system may suggest sponsored content based, for example, on what other users have selected, or in some cases may suggest both licensed content and sponsored content. For example, a user having indicated an interest in country music may be presented the latest Carrie Underwood song and video advertisements for Ford trucks. In some embodiments, users can search previously created parings created by other users as suggestions, and, in some cases, view and/or download the paring if the licensing and distribution restrictions permit. Users may also, in some versions, preview the licensed content and/or sponsored content, which itself may generate revenue for the licensor and/or the website administrator.

In some cases, sponsors and/or content licensors may promote contests among the users and encourage (or require) the use of certain content. For example, a movie studio releasing a new movie may provide clips from the movie and sponsor a contest among users to create a new commercial for the movie, resulting in multiple custom movie trailers. In such cases, a participant in the contest may be required to use a clip (or set of clips) from the movie and pair the clips with music of her choice. The movie studio may provide a branded, skinned or sponsored web page for the contest where users may view, vote on and/or comment on the custom trailers. Winners may be compensated through recognition on the website, cash prizes, invitations to screenings, meeting with cast members, or other valuable prizes.

Once the user U selects licensed content and sponsored content (STEP 248), the mixing module 132 (FIG. 1) edits the selected content (STEP 252) such that the length of the sponsored content matches (although not necessarily exactly the same) the length of the licensed content. For example, the mixing module 132 can, in some implementations, automatically adjust the length of a video advertisement to match the length of a song, thus creating a music video, using the advertisement as the video track and the song as the audio track. In some embodiments, the user may perform the editing tasks and/or provide her own user-generated content. In some implementations, the sponsored content and/or licensed content includes discreet segments that may selected individually or as a group to provide a greater degree of flexibility and creativity to the user as she creates her custom presentation. The mixing module 132 then checks for content restrictions (e.g., for unauthorized pairing of content with unwanted sponsored content and vice versa) and applies any distribution restrictions (e.g., requires license key, limited to 100 distributions, expires after 30 days, etc.) (STEP 256). As an example, if a user wishes to pair a recently-released song by Korn and a snowboard video provided by a snowboard manufacturer, the system confirms that the record label (and in some cases the artist) providing the song and the snowboard company permit (or do not explicitly prohibit) such a combination. If the combination is allowed, the system mixes the two (STEP 260), thus creating a custom music video for presentation and/or transmission to the user (STEP 264). The music video can be provided as a stand-alone file (e.g., an MPEG file, WMV file, etc.) or, in some cases, as a unique identifier that allows the user to connect to the content server and stream the video to a client device on demand. The user may then watch and/or listen to the presentation (STEP 268) on his client device. In some implementations, he may decide not to pair the content with an advertisement, in which case the user can elect to purchase the content directly from the system, similar to the iTunes service provided by APPLE COMPUTER COMPANY of Cupertino, Calif. In other cases, an advertiser may elect to “sponsor” content (e.g., pay the license fees for a song, movie, television show, sports event, etc.) and allow users to download and view the content without requiring the pairing with any advertisements. In some embodiments, users may also be presented with additional opportunities to purchase additional merchandise such as clothing, concert tickets, memberships in fan clubs and the like. Once complete, the user-created media presentation may then be “saved” to the user's personal studio (STEP 270) for future viewing, downloading and/or distribution. In some embodiments, the user is then directed to a sponsored web page that includes more information about the products and services offered by the sponsor.

The licensor provides licensed content in anticipation that it will be compensated for its use and distribution. The compensation will typically be in the form of monetary payments from the sponsor(s) that provide the sponsored content that is paired with the licensed content, and/or user(s) who download the content. As such, when licensed content is used to create custom media content and/or distributed to users, payment instructions are sent (STEP 272) to whichever party (the sponsor in most cases) has agreed to pay the license fee. Using the snowboard video example from above, once the music video is created by the user and downloaded, the snowboard company is sent payment instructions so that it may compensate the record label that provided the song, and the user receives (or is provided access to) the combined song and video for free. The sponsor receives the payment instructions (STEP 276), sends the payment to the licensor (STEP 280), and in some embodiments a fee is also paid to the entity operating the website. The payment(s) are received by the licensor (STEP 284), thus compensating the licensor for providing the content. In some alternative embodiments, the payment information is kept within the system, and payment instructions are processed periodically (e.g., monthly, quarterly) and payments can thus be made in bulk. In other implementations, the sponsors and licensors maintain “accounts” within the system such that all payments can be effectuated within the system (again, either periodically, per transaction, or some other method as selected by the licensor and/or sponsor), thus eliminating the need for direct payments between the parties.

In some embodiments, the user may decide to distribute his custom presentation to other users (STEP 288). Distribution methods include, for example, posting a link to the presentation on a web page (e.g., a MySpace page or blog page), emailing a link to the presentation, and/or sending the actual file. In instances in which a link (or some other unique content identifier) is distributed, the receiving user selects the link or identifier using, for example, a web browser which transmits the link to the server, where the distribution request is received and processed (STEP 292). The server checks any distribution restrictions, confirms that the identifier and any required keys are valid, and tracks the distribution (STEP 296), thus allowing additional license payments to be made, if stipulated.

As a result, the users gain access to licensed content at no charge—a model that, although not embraced by content licensors, has become ubiquitous throughout the industry. However, unlike illegal file-swapping websites and methods, a licensor may be compensated for its content by sponsors who are searching for new ways to distribute marketing messages, commercials and other advertisements. The sponsors pay the licensors for the “privilege” of having such messages paired with licensed content, and, if permitted, to have the result distributed across the Internet through viral marketing, social networking, and email. In some cases, sponsors select one or more of the user-created media presentations and use the presentations for additional marketing campaigns.

### Exemplary Implementation

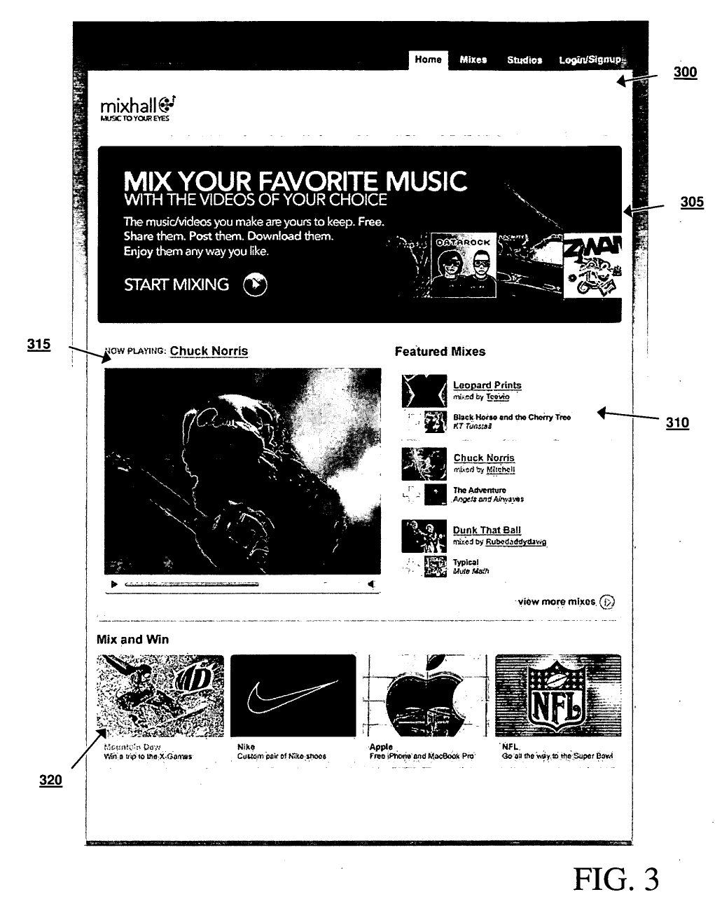

FIGS. 3-6 are illustrative application screens from one exemplary implementation of the system described above. More specifically, FIG. 3 is an example of a home page 300 that includes a main advertising section 305, a featured mix section 310, a video playback section 315 and a sponsored content section 320. Advertising section 305 may be used to present website visitors with information about the platform, new functionality, upcoming contests, newly signed sponsors and/or licensing partners. Artwork such as album covers and images from videos may also be presented to encourage users to select specific content for mixing. The featured mix section 310 includes a list of user-created custom media presentations available for viewing. The list may include the most recently created presentations, the most popular presentations, or those presentations that match metadata associated with the user. In some instances, users rate presentations (e.g., 1-5 stars) and those presentations with a high average rating are featured.

Still referring to FIG. 3, the video playback section 315 includes a video player for rendering videos available for inclusion into custom presentations, allowing users to preview the sponsored content. The video player may also be used to play the custom media presentations once created. In some implementations, the video player includes a commercially-available player such as WinAmp or WINDOWS MediaPlayer, which may be embedded in the page 300.

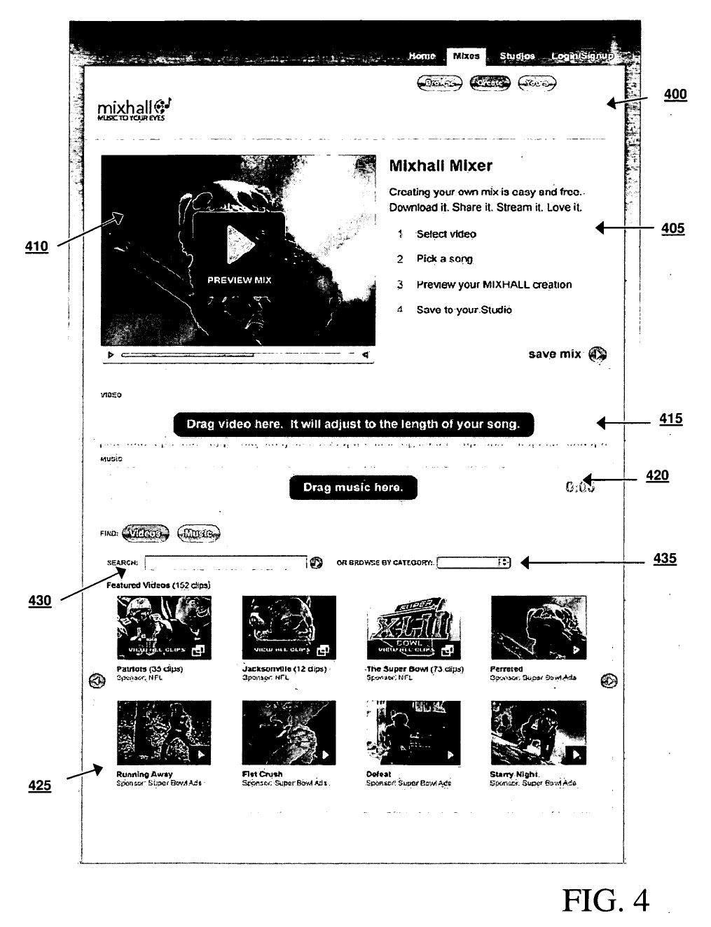

FIG. 4 is an example application screen 400 for creating custom media presentations using sponsored video content. The screen includes instructions 405 for crating the custom presentation and a player 410 for rendering the presentation. The page 400 also includes a video timeline 415 and audio timeline 420 into which the user drags a selected video (or videos) and selected audio for combining into the custom presentation. Also provided is a video library 425 of sponsored content available to the user for mixing. The video library 425 may include the most recently added sponsored content, the most popular content, content provided by sponsors offering the most money for use, or sponsors promoting contests. In some cases, the content presented is based on an algorithmic search of the content library that identifies content having similar attributes to recently viewed and/or used content. In some implementations, users may suggest content to other users via email or other messaging modalities.

Users may also search for content based on content metadata such as title, artist, sponsor, genre, date, product or other keywords using keyword search function 430. Alternatively, a category-based search 435 may be used to search for content based on broad topics such as trucks, movies, travel, etc.

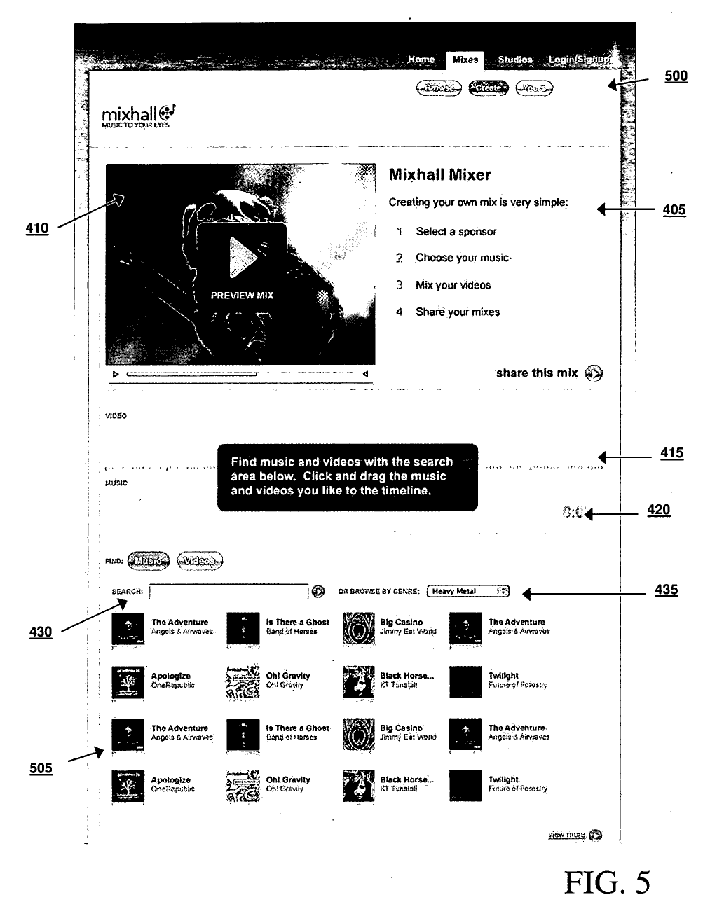

FIG. 5 is an illustrative audio selection screen 500 that provides access to an audio library 505 and similar mixing, playback and searching functionality as shown on FIG. 4. In implementations in which the user is combining licensed music with sponsored video as described above, the audio library 505 includes a listing of songs available for inclusion into the custom media presentation. The listing may include information about the songs such as title, artist, record label, album art, liner notes, biographical information, upcoming concert dates, running length, genre, as well as other metadata. In some cases, the metadata is provided by the content licensor, whereas in other cases user may add metadata to the listing.

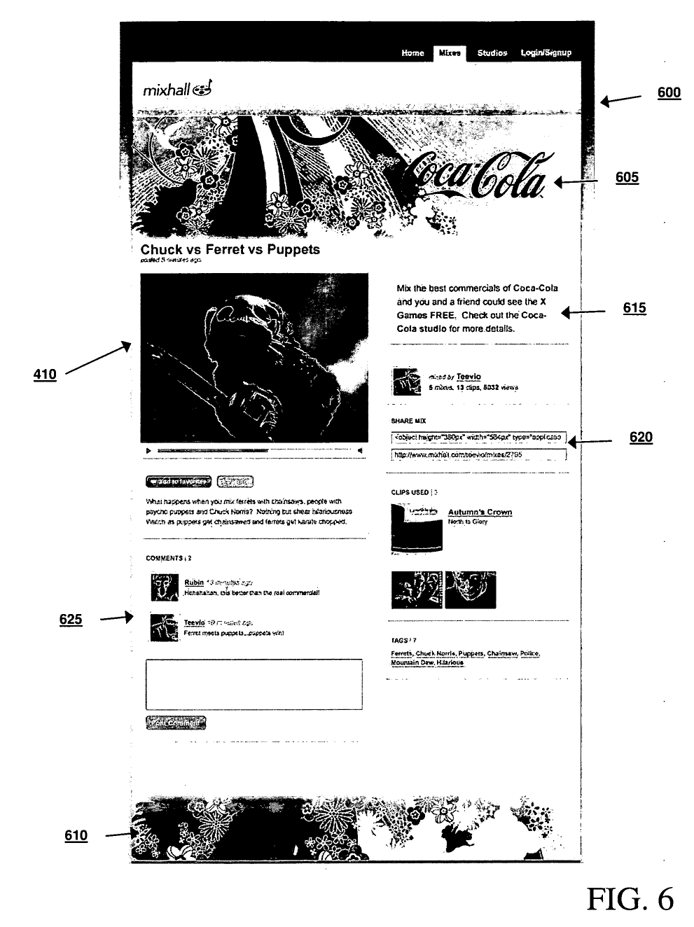

In some implementations, content sponsors may wish to sponsor a “branded” version of the platform. The branded site may, for example, include sponsored content provided exclusively from the sponsor, trademarks, logos, art, colors, skins and themes designed by the sponsor and in some cases aligned with marketing campaigns. FIG. 6 illustrates one example of a branded landing page 600 having Coca-Cola as the sponsor. The famous Coke trademark 605 is prominently displayed on the page 600, and the overall color theme uses “Coke red.” A call to action 610 encourages the user to create new commercials for Coke using the available content, and provides information about upcoming contests. In some implementations, a sponsor may be running multiple contests for different products, geographic regions, market segments, etc. The sponsored page 600 (as well as the pages illustrated on FIGS. 3-5) may also include a instructions and text 620 to allow a user to share a presentation created by another user. The text may include an HTML tag and/or URL that, when copied into the source code of a web page, provides a link to the presentation as stored on the server 104 (FIG. 1).

In some implementations, users submit the custom created presentations to the sponsor for review prior to being made available on the site, whereas in other cases they are immediately posted for public viewing. The review process may include screening for inappropriate content and/or copyright infringements, for example. For contests, the sponsor may review the submitted presentations and select one or more presentation as winning presentations. The winning presentations may be used in upcoming marketing campaigns, thereby allowing marketing professionals to receive and review potential marketing content as designed by members of the public, often from a target market segment. The submitted presentations may be reviewed by focus groups, marketing professionals and others to generate marketing ideas.

The invention can be embodied in other specific forms without departing from the spirit or essential characteristics thereof. The foregoing embodiments are therefore to be considered in all respects illustrative rather than limiting on the invention described herein.

What is claimed is:

1. A method for providing electronic media content to users, the method comprising:
presenting a plurality of licensed media content files to a user, each of the media content files being attributed to a content licensor;
presenting a plurality of sponsored media files to a user, each of the sponsored media files being attributed to a sponsor;
receiving, from the user, a request to combine one or more of the licensed media content files with one or more of the sponsored media files; and
combining the one or more requested licensed media content files and the one or more requested sponsored media files, thus creating a user-specified media presentation.

2. The method of claim 1 wherein the plurality of licensed media content files comprises one or more of audio files, video files and any combinations thereof.

3. The method of claim 1 wherein the content licensor comprises one or more of a record company, artist, and any combinations thereof.

4. The method of claim 1 wherein the licensed media content files and sponsored content files are presented to the user over an electronic network.

5. The method of claim 1 further comprising modifying the one or more requested licensed media content files or sponsored content files prior to the combination step.

6. The method of claim 5 wherein the modification of the one or more requested licensed media content files or sponsored media files is based at least in part on attributes of the one or more requested sponsored content files.

7. The method of claim 1 further comprising determining whether the combination of the one or more requested licensed media content files with the one or more requested sponsored content files violates content restriction policies.

8. The method of claim 7 wherein the content restriction policies are supplied, at least in part, by one or more of the content licensor and the sponsor to which the one or more requested licensed media content files and one or more requested sponsor media files are attributed.

9. The method of claim 1 further comprising facilitating payment of licensing fees from the sponsor with which the one or more requested sponsored media files are attributed to the content licensor with which the one or more requested licensed media content files are attributed.

10. The method of claim 1 further comprising presenting the user-specified media presentation to the user.

11. The method of claim 1 further comprising transmitting the user-specified media presentation to a client device.

12. The method of claim 1 further comprising storing the user-specified media presentation on a content server.

13. The method of claim 12 further comprising providing a content identifier to the user, the content identifier facilitating the identification and retrieval of the user-specified media presentation from the content server.

14. The method of claim 13 further comprising receiving a retrieval request comprising the content identifier, and, in response to receiving the retrieval request, providing the user-specified media presentation.

15. The method of claim 14 wherein the retrieval request is received from the user.

16. The method of claim 14 wherein the retrieval request is received from a requester other than the user.

17. The method of claim 14 wherein the retrieval request and the provision of the user-specified media presentation are received from and provided to different users respectively.

18. The method of claim 14 further comprising monitoring retrieval requests and responses thereto, thus tracking one or more of a number of requests, a number of responses, users submitting requests, and requesters to which the user-specified media presentation is provided.

19. The method of claim 18 further comprising facilitating payment of licensing fees from the sponsor to which the one or more requested sponsor content files is attributed to the content licensor to which the one or more of the requested licensed media content files is attributed based on the results of results of the monitoring step.

20. The method of claim 18 wherein the monitoring of the receipt of retrieval requests and the responses thereto further comprises determining if the received request and associated response thereto comply with one or more distribution restriction policies.

21. A method for providing free advertising-sponsored music downloads to consumers, the method comprising:
receiving, from a consumer, a request to combine a music file supplied by a first entity with a video advertisement file attributed to a second entity, both the music file and the video advertisement file being selected by the user;
determining one or more attributes of the music file and one or more attributes of the video advertisement file;
modifying one or more of the music file and the video advertisement file based at least in part on the one or more attributes of the music file and the video advertisement file;
combining the music file and the video advertisement file, thus creating a user-specified media presentation; and
facilitating the payment of licensing fees from the second entity to the first entity.

22. A system for providing electronic media content to users, the system comprising:
a content server for receiving a plurality of media content files, a first subset of the licensed media content files being attributed to a content licensor and a second subset of the media content files being attributed to a sponsor;
a client communication server for receiving, from a first client device, a request to combine media content files from the first subset with media content from the second subset;
a mixing module for combining the requested media content files, thus creating a user-specified media presentation; and
a payment module for determining a payment from the sponsor to the content licensor.

23. The system of claim 22 further comprising a database server for storing the media content files and the user-specified media presentation.

24. The system of claim 22 wherein the client communication server further receives requests to provide the user-specified media presentation to one or more of the client device and other client devices.

25. The system of claim 24 further comprising a licensing server for determining whether the received requests comply with one or more distribution restriction policies.
